(19) United States
(12) Patent Application Publication
(10) Pub. No.: US 2024/0110808 A1
(43) Pub. Date: Apr. 4, 2024

(54) METHOD AND CONTROL DEVICE FOR ACTIVATING A DISPLAY DEVICE OF A NAVIGATION SYSTEM OF A VEHICLE, DISPLAY DEVICE, AND VEHICLE

(71) Applicant: Volkswagen Aktiengesellschaft, Wolfsburg (DE)

(72) Inventors: Alexander Kunze, Braunschweig (DE); Yannis Tebaibi, Braunschweig (DE)

(21) Appl. No.: 18/479,757

(22) Filed: Oct. 2, 2023

(30) Foreign Application Priority Data
Oct. 4, 2022 (DE) 102022210497.8

(51) Int. Cl. G01C 21/36

(52) U.S. Cl. CPC G01C 21/3658; G01C 21/365

(57) ABSTRACT

Technologies and techniques for activating a display device of a navigation system of a vehicle during a lane change of the vehicle. A lane change prompt is detected and a lane boundary for the lane change prompt is determined. A reference line is provided for the lane boundary in a field of view of the display device, and a lane change indication is provided with the aid of the reference line on the display device. The reference line may then be arranged in a field of view of the display device in such a way that the reference line is positioned in a field of view through a vehicle window of the vehicle at a certain lateral distance with respect to the lane boundary.

### RELATED APPLICATIONS

The present application claims priority to German Pat. App. No. 10 2022 210 497.8 filed Oct. 4, 2022, the contents of which is incorporated by reference in its entirety herein.

### TECHNICAL FIELD

The present disclosure relates to technologies and techniques for activating a display device of a navigation system of a vehicle. The present disclosure furthermore relates to a corresponding computer program product for carrying out a corresponding method. The present disclosure moreover relates to a corresponding control device for carrying out a corresponding method. The present disclosure also relates to a corresponding display device comprising a corresponding control device and to a corresponding vehicle comprising a corresponding display device.

### BACKGROUND

Displays are always used in modern vehicles and are intended to support the operation of the vehicle. Some displays in the context of automobile navigation show a target lane on a roadway on a graphical representation of the environment. Such information requires a high-resolution representation as well as a large display surface area, which is why, in most instances, the information is displayed on an instrument cluster or on a central vehicle screen, which, however, requires the user to avert his or her gaze from the environment onto the display. In addition, the represented information has to be cognitively transferred from the graphic to reality, that is, the user has to continuously compare the graphic representation with the actual traffic situation. This requires a high cognitive effort for a user of the vehicle. A display in a head-up display can avoid that the user averts his or her gaze. The disadvantage with head-up displays, however, is that a very broad field of view (FOV) is required so as to map the lane boundaries of a roadway realistically. Head-up displays reach their limits in particular during turning maneuvers when the field of view is also to cover the adjoining lane. The installation of large head-up displays is also problematic since the required installation space cannot be implemented in many vehicles.

Some aspects of the present disclosure are directed to providing improved configurations for activating a display device of a navigation system of a vehicle. Some aspects of the present disclosure are directed to providing improved configurations for activating a display device of a navigation system of a vehicle, which avoids that the user having to avert his or her gaze from the traffic situation, which reduces the cognitive burden on the user during the interpretation of the traffic situation, which can be carried out easily and with little computing effort, and which capitalizes on the possibilities of augmented reality (AR), in particular in conjunction with head-up displays, so as to enable an improved, simple, comprehensible and intuitively understandable representation of navigation indications in the field of vision of the user through a vehicle window, during a lane change of the vehicle. Some aspects of the present disclosure are directed to providing a corresponding computer program product for carrying out the corresponding methods. Some aspects of the present disclosure are directed to providing a corresponding control device for carrying out the corresponding methods. In addition, some aspects of the present disclosure are directed to providing a corresponding display device comprising a corresponding control device, and a corresponding vehicle comprising a corresponding display device.

In some examples, a method, a corresponding computer program product, a control device, a display device and/or a vehicle are disclosed for activating a display device of a navigation system of a vehicle having the features recited in the claims below. Further features, advantages and details of the present disclosure will be apparent from the dependent claims, the description and the drawings. Features and details that are described in connection with individual aspects according to the present disclosure also apply in connection with the other aspects according to the present disclosure, and vice versa, so that mutual reference is made, or can be made, in each case to the individual aspects of the present disclosure with respect to the disclosure.

In some examples, a method is disclosed for activating a display device of a navigation system of a vehicle, which can comprise a head-up display, for example, so as to enable a representation of navigation indications in the field of vision of the user through a vehicle window, in particular during a lane change of the vehicle, the method comprising: detecting a lane change prompt, wherein the lane change prompt, for example, can come from a user of the vehicle as the driver and/or from a control device of the vehicle when the vehicle is driving in an automated mode or is designed as an autonomous vehicle, wherein a turn request can be subsumed under a lane change prompt; determining a lane boundary for the lane change prompt, wherein a lane boundary may be interpreted as a roadway boundary and/or a traffic lane boundary or a roadway marking; providing a reference line for the lane boundary in a field of view of the display device, wherein a reference line can in particular be understood to mean a graphical image of the lane boundary on a display of the display device, wherein the size of the display can preferably determine a field of view of the display device; providing a lane change indication with the aid of the reference line on the display device, wherein a lane change indication can be understood to mean a graphical piece of information that is intended to visualize the direction of the lane change according to the lane change prompt, and wherein a turn indication can preferably be subsumed under a lane change indication, wherein the reference line is arranged in a field of view of the display device in such a way that the reference line is positioned or appears in a field of view through a vehicle window of the vehicle at a certain, deliberately selected, lateral distance with respect to the lane boundary.

The technologies and techniques disclosed in the method can preferably be used for automated, highly automated or autonomously driving vehicles.

In some examples, a computer program product is disclosed, encompassing commands that, when the computer program is being executed by a computer, prompt the computer to carry out the methods as disclosed herein. With the aid of the computer program product according to the present disclosure, the same advantages as those described in connection with the above-described method can be achieved. All these advantages are hereby incorporated by reference.

In some examples, a control device is disclosed for activating a display device of a navigation system of a vehicle, comprising: a memory device and a computing device, wherein a code is stored in the memory device, and wherein, during the execution of the code by the computing device, the methods disclosed herein are carried out. With the aid of the control device according to the present disclosure, the same advantages as those described in connection with the above-described method can be achieved. All these advantages are hereby incorporated by reference.

In some examples, a display device is disclosed, comprising a control device, which can be designed as described herein. With the aid of the display device according to the present disclosure, the same advantages as those described in connection with the above-described method can be achieved. All these advantages are hereby incorporated by reference.

In some examples, a vehicle is disclosed, comprising a display device, which can be designed as described herein. With the aid of the vehicle according to the present disclosure, the same advantages as those described in connection with the above-described method can be achieved. All these advantages are hereby incorporated by reference.

### BRIEF DESCRIPTION OF THE DRAWINGS

Additional advantages, features and details of the present disclosure will be apparent from the following description, which describes in detail exemplary embodiments of the present disclosure with reference to the drawings. The features described in the claims and in the description can be essential to the present disclosure either alone or in any arbitrary combination. In the drawings:

FIG. 1 shows a schematic representation of a lane boundary, according to some aspects of the present disclosure;

FIG. 2 shows another representation of a lane boundary, according to some aspects of the present disclosure; and

FIG. 3 shows yet another representation of a lane boundary, according to some aspects of the present disclosure.

### DETAILED DESCRIPTION

In the various examples described herein the gaze of the user may fall through the field of view of the display device and through the field of view through the window of the vehicle, on the environment of the vehicle, and thus on the roadway ahead of the vehicle.

In some examples, the display of the display device does not need to cover the entire width of the vehicle window. The display of the display device also does not need to cover the entire field of view through the vehicle window. The field of view of the display device can in particular be smaller than the field of view through the window of the vehicle.

Lateral distances, and possibly further distances within the scope of the present disclosure can be measured on a selected vertical coordinate of the display. It may be noted that the addressed ratios with respect to the width of the fields of view do not change in terms of the selected vertical coordinate.

The display device can preferably capitalize on augmented reality (AR) technologies, in particular in conjunction with head-up displays. The field of view of the display device can be provided by the head-up display.

Under some examples, an improved augmented lane change display can be provided with the aid of a display device having a simple design, which can have a smaller field of view compared to the vehicle window. By placing a reference line (e.g., formed by several triangles in one possible exemplary embodiment), the lane boundary is represented in the field of view of the display device. The representation does not take place superimposed with the actual lane boundary in the field of view through the vehicle window or in the view of the user. The reference line appears in the field of view through the vehicle window at a lateral distance with respect to the lane boundary. Using the reference line decreases the requirements with regard to the size of the field of view of the display device since the reference line can be located within the visible lane ahead of the vehicle, as viewed in the field of view through the vehicle window. The defined positioning of the reference line at a deliberately selected lateral distance with respect to the lane boundary, as viewed in the field of view through the vehicle window, however, ensures easy perception and intuitive comprehensibility of the representation of the lane boundary and of the lane change indication associated therewith.

The reference line can furthermore be adapted, and in particular dynamically adapted, to the road curvature. The reference line can, for example, be penetrated by an S-shaped arrow so as to provide a lane change indication. The lane change indication can furthermore be provided by the reference line itself, for example by a corresponding curvature, flection and/or bend of the reference line, preferably in the direction of the lane change prompt.

The reference line, however, can also be depicted by way of the lane to be traveled by the vehicle, which, for example, can be provided with a pattern-like, shaded and/or colored progression, which can preferably increase in the direction of the lane change prompt.

In some examples, the reference line can advantageously be placed within the field of view through the vehicle window as close as possible to the actual roadway marking, however without the reference line intersecting the field of view boundary and/or without the perspective of the reference line being distorted compared to the lane boundary.

The reference line in the field of view of the display device can be scaled corresponding to the difference in size between the field of view through the vehicle window and the field of view of the display device. In this way, the reference line can be shifted in the field of vision of the user in the direction of the roadway center. A perspective representation of the reference line can advantageously support the AR effect. This results in an advantageous AR effect, even with smaller display devices, which helps to reduce the cognitive burden on the user.

The display can be supported by a symbolic representation of other lanes, which can be iconographically represented. In this way, it is possible to communicate several necessary lane changes. This can be advantageous on a multi-lane highway, for example.

As a result, the lane change prompt can advantageously be visualized with the aid of augmented reality technologies, even in vehicles that have limited installation space and/or small display devices.

In some examples, only one reference line may be represented for a (or for each) lane change prompt. As a result, a simple representation of the lane boundary can be made possible. The computing requirement during the control process and the requirements with regard to the graphics can thus be reduced.

Furthermore, it may be provided that, in the case of a multiple lane change prompt, a reference line is depicted in each case for each impending lane change, wherein in particular the reference lines can be arranged corresponding to a sequence of impending lane changes, and in particular consecutively. In this way, several necessary lane changes can be communicated with the aid of AR effects. This can be advantageous on a multi-lane highway, for example.

In some examples, the certain lateral distance may be set in such a way that the reference line essentially maps an overall appearance of the lane boundary in the field of view through the vehicle window onto the field of view of the display device, without intersecting a boundary of the field of view of the display device in the direction of the lane boundary and/or without distorting the perspective of the reference line compared to the perspective of the lane boundary. In this way, a comprehensible representation of the lane boundary can also be made possible with the aid of small display devices.

Moreover, it may be provided that the certain lateral distance is set in such a way that a ratio between a width of the field of view through the vehicle window and a width of the field of view of the display device is taken into consideration. In this way, the design conditions in the vehicle can advantageously be taken into consideration so as to amplify the AR effect to as great an extent as possible.

In addition, it may be provided that the certain lateral distance is set proportionally to a ratio between a width of the field of view through the vehicle window and a width of the field of view of the display device. In this way, a larger distance may possibly be set in the case of smaller display devices than in the case of larger display devices, in comparison to the field of view through the vehicle window. As a result, a reproducible representation of the lane boundary can be provided on display devices having different sizes. In this way, it also becomes possible to switch between differently sized display devices or differently sized switching areas of the display devices.

Furthermore, it may be provided that the reference line in the field of view of the display device, in relation to an appearance of the lane boundary in the field of view through the vehicle window, is represented in a corresponding perspective view. An advantageous AR effect can thus be generated, which can help to considerably reduce the cognitive burden on the user.

Moreover, it may be provided that the reference line in the field of view of the display device, in relation to an appearance of the lane boundary in the field of view through the vehicle window, is represented in a corresponding scaled view. A ratio between a width of the field of view of the display device and a width of the field of view through the vehicle window is a conceivable proportional ratio. The design conditions in the vehicle can thus advantageously be taken into consideration so as to achieve an enhanced AR effect.

Furthermore, it may be provided that the reference line is arranged at a certain, in particular scaled, distance with respect to a boundary of the field of view of the display device in the direction of the lane boundary. An overlap of the boundary of the field of view by the reference line can thus be prevented, which could impair the visual effect.

Advantageously, the distance between the reference line and a boundary of the field of view of the display device in relation to a distance between the lane boundary and a corresponding boundary of the field of view through the vehicle window can be set in an accordingly scaled manner. A ratio between a width of the field of view of the display device and a width of the field of view through the vehicle window is a conceivable proportional ratio. A simple representation of the lane boundary can thus be made possible, which requires little computing effort during the control process.

So as to increase the visual perceptibility of the representation, the reference line can be represented by a plurality of signs, for example in the form of triangles, which are in particular symmetrically arranged with respect to one another.

In some examples, the reference line can be represented by a shading of a depicted lane of the vehicle, which is in particular represented with greater intensity in the direction of the lane change prompt, and/or that the reference line can be represented by a progression of a pattern of a depicted lane of the vehicle, which is in particular represented more densely in the direction of the lane change prompt, and/or that the reference line can be presented by a color progression of a depicted lane of the vehicle, which in particular changes in the direction of the lane change prompt. This way, different representations of the lane change indication can be made possible.

Advantageously, different representations of the reference line can be provided within the scope of user settings. The user friendliness when carrying out the method can thus be increased.

In addition, it is conceivable that the lane change indication can be represented in the form of a directional indication, in particularly in the form of an S-shaped arrow, which can preferably penetrate the reference line. A simple representation of the lane change indication can thus be made possible, which has low requirements with regard to the graphics.

In addition, it is conceivable that the lane change indication can be represented by the reference line itself, in particular by a curvature, flection and/or a bend of the reference line, preferably in the direction of the lane change prompt As a result, an appealing, easy-to-understand representation of the lane change indication can be made possible.

Advantageously, different representations of the lane change indication can be provided within the scope of user settings. The user friendliness when carrying out the method can thus be increased.

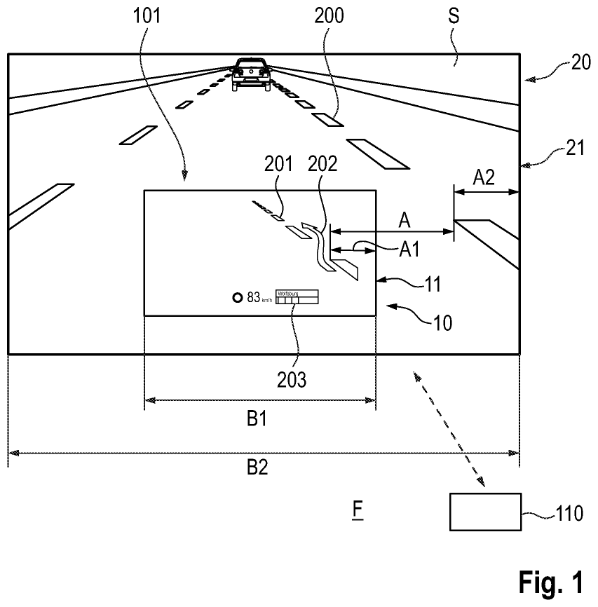

FIGS. 1 to 3 are provided to describe a method for activating a display device 101 of a navigation system 100 of a vehicle F, such as an automated, highly automated or autonomously driving vehicle F. The display device 101 can, for example, comprise a head-up display so as to represent navigation indications in the field of vision of the user through the vehicle window S, in particular during a lane change of the vehicle F.

The method comprises:
detecting a lane change prompt.
   In some examples, the lane change prompt may come from a user of the vehicle F as the driver and/or from a control device of the vehicle F when the vehicle F is driving in an automated mode or is designed as an autonomous vehicle.
   A lane change prompt can additionally be understood to mean a turn request.

The method furthermore comprises:
determining a lane boundary 200 for the lane change prompt.
   A lane boundary can be understood to mean a roadway boundary, a traffic lane boundary or a roadway marking.

The method furthermore comprises:
providing a reference line 201 for the lane boundary 200 in a field of view 10 of the display device 101.
   A reference line can be understood to mean a graphical image of the lane boundary 200 on a display of the display device 101. The size of a corresponding display of the display device 101 can determine the field of view of the display device 101.

The method furthermore comprises:
providing a lane change indication 202 with the aid of the reference line 201 on the display device 101.

A lane change indication 202 can be understood to mean a graphical piece of information that is intended to visualize the direction of the lane change according to the lane change prompt.

A lane change indication can furthermore be understood to mean a turn indication.

In this example, the reference line 201 may be arranged in such a way in the field of view 10 of the display device 101 that the reference line 201 appears in a field of view 20 through a vehicle window S of the vehicle F at a certain, in provided deliberately selected, lateral distance A with respect to the lane boundary 200.

Here, the gaze of the user falls, through the field of view 10 of the display device 101 and through the field of view 20 through the vehicle window S of the vehicle F, on the environment of the vehicle, and thus on the roadway ahead of the vehicle.

The display of the display device 101 can be designed to be smaller than the vehicle window S. The display or the field of view 10 of the display device 101 does not need to cover the entire field of view 20 through the vehicle window S.

In this way, an improved augmented lane change display can be implemented, which can be preferably be provided with the aid of a display device 101 having a simple design, which can have a smaller field of view 10 compared to the vehicle window S.

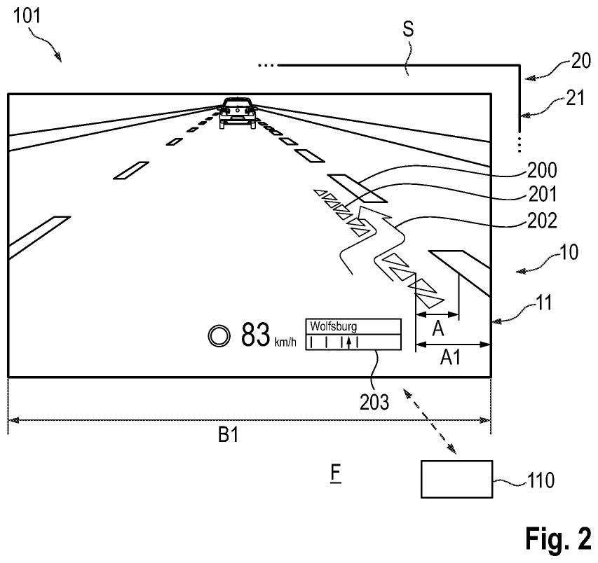

The reference line 201 (formed by several triangles in one possible exemplary embodiment of FIG. 2) represents the lane boundary 200 in the field of view 10 of the display device 101. The representation of the lane boundary 200 does not take place superimposed with the actual lane boundary 200, as viewed in the field of view 20 through the vehicle window S or in the view of the user. The reference line appears in the field of view 20 through the vehicle window S at a lateral distance A with respect to the lane boundary 200. The reference line 201 thus appears within the visible lane ahead of the vehicle F. The defined positioning of the reference line thus takes place at a deliberately selected lateral distance with respect to the lane boundary 200 for easy perception and intuitive comprehensibility of the representation of the lane boundary 200 and of the lane change indication 202 associated therewith.

The reference line 201 can furthermore be adapted to the road curvature. The adaptation can take place dynamically.

As is indicated in FIG. 2, the reference line 201 can be represented by a plurality of signs, for example in the form of triangles, which are in particular symmetrically arranged with respect to one another.

As FIGS. 1 and 2 show, the reference line 201 can, for example, be penetrated by an S-shaped arrow so as to provide a lane change indication 202. The arrow can point in the direction of the lane change.

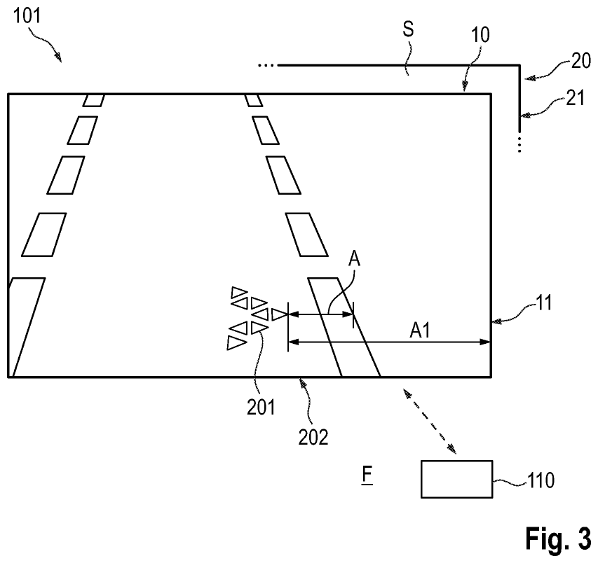

As is shown in FIG. 3, the lane change indication 202 can furthermore be provided by the reference line 201 itself, for example by a corresponding curvature, flection and/or bend of the reference line 201, preferably in the direction of the lane change prompt.

Different representations of the reference line 201 and/or of the lane change indication 202 can be provided within the scope of user settings for selection by the user.

The reference line 201, however, can also be depicted by way of the lane to be traveled by the vehicle F, which, for example, can be provided with a pattern-like, shaded and/or colored progression, which can preferably increase or be intensified in the direction of the lane change prompt.

The reference line can advantageously be placed within the field of view 20 through the vehicle window S as close as possible to the actual lane boundary 200 in the field of vision of the user, however without the reference line 201 intersecting a field of view boundary 11 of the field of view 10 of the display device 101 and/or without the perspective of the reference line 201 being distorted compared to the lane boundary 200.

The reference line 10 in the field of view of the display device 101 can be scaled corresponding to the difference in size between the field of view 20 through the vehicle window S and the field of view 10 of the display device 101. In this way, the reference line 201 can be shifted in the field of vision of the user in the direction of the roadway center. A perspective representation of the reference line 201 can advantageously support the AR effect. This yields an advantageous AR effect, even with smaller display devices 101, whereby the lane change prompt can be easily perceived and intuitively understood.

The display can be supported by a symbolic representation 203 of other lanes, which can be iconographically represented. In this way, it is possible to communicate several necessary lane changes. This can be advantageous on a multi-lane highway, for example.

As a result, the lane change prompt can advantageously be visualized with the aid of augmented reality technologies, even in vehicles F that have limited installation space for display devices 101.

In principle, a reference line, in particular exclusively one reference line 201, can be represented per lane change prompt.

Furthermore, in the case of a multiple lane change prompt, a reference line 201 can be depicted in each case for each impending lane change, wherein in particular the reference lines 201 can be arranged corresponding to a sequence of impending lane changes, and in particular consecutively.

The certain lateral distance A between the reference line 201 and the actual lane boundary 200 can be set in such a way that a ratio V21 between a width B2 of the field of view 20 through the vehicle window S and a width B1 of the field of view 10 of the display device 101 is taken into consideration.

A=f(V21),V21=B2/B1.

In the case of differently sized display devices 101, the certain lateral distance A can be set proportionally to a ratio V21 between a width B2 of the field of view 20 through the vehicle window S and a width B1 of the field of view 10 of the display device 101.

A≈V21=B2/B1.

As FIGS. 1 and 2 indicate, the reference line 201 in the field of view 10 of the display device 101, in relation to the appearance of the lane boundary 200 in the field of view 20 through the vehicle window S, can be represented in a corresponding perspective and/or corresponding scaled manner. A ratio V12 between a width B1 of the field of view 10 of the display device 101 and a width B2 of the field of view 20 through the vehicle window S can be selected as a proportional ratio.

V12=B1/B2.

As FIGS. 1 and 2 indicate, the reference line 201 can be arranged a certain, in particular scaled, distance A1 with respect to a boundary 11 of the field of view 10 of the display device 101 in the direction of the lane boundary 200.

The distance A1 between the reference line 201 and the boundary 11 of the field of view 10 of the display device 101, in relation V2 to a distance A2 between the lane boundary 200 and a corresponding boundary 21 of the field of view 20 through the vehicle window S, can be set in an accordingly scaled manner. A ratio V12 between a width B1 of the field of view 10 of the display device 101 and a width B2 of the field of view 20 through the vehicle window S is conceivable as a proportional ratio:

V12=A1/A2=B1/B2.

All distances A, A1, A2 can, for example, be measured on any vertical coordinate of the field of view 10 and/or of the field of view 20, however in each case between respective corresponding parts of the reference line 201 and/or the lane boundary 202 and the respective boundary 11, 21. The aforementioned ratios V21, V12 with respect to the width B1, B2 of the fields of view 10 advantageously do not change as a function of the selected vertical coordinate.

FIGS. 1 to 3 schematically show a control device 110 for activating a display device 101 of a navigation system 100 of a vehicle F, which likewise represents an aspect of the present disclosure.

FIGS. 1 to 3 schematically show a display device 101, which likewise represents an aspect of the present disclosure.

FIGS. 1 to 3 schematically show a vehicle F, which likewise represents an aspect of the present disclosure.

The above description of the embodiments exclusively describes the present disclosure based on examples. If technically expedient, individual features of the embodiments can, of course, be freely combined with each other without departing from the scope of the present disclosure.

### LIST OF REFERENCE SIGNS

10 field of view
11 boundary
20 field of view
21 boundary
100 navigation system
101 display device
110 control device
200 lane boundary
201 reference line
202 lane change indication
203 symbolic/iconographical representation
A distance
B1 width
B2 width
F vehicle
S vehicle window
V12 ratio
V21 ratio

1. A method for activating a display device of a navigation system of a vehicle during a lane change of the vehicle, comprising:
detecting a lane change prompt;
determining a lane boundary for the lane change prompt;
providing a reference line for the lane boundary in a field of view of the display device; and
providing a lane change indication with using the reference line on the display device, wherein the reference line is arranged in a field of view of the display device in such a way that the reference line is positioned in a field of view through a vehicle window of the vehicle at a configured lateral distance with respect to the lane boundary.

2. The method according to claim 1, wherein only one reference line is represented for a lane change prompt.

3. The method according to claim 1, wherein, in the case of a multiple lane change prompt, a reference line is depicted in each case for each impending lane change, the reference lines being arranged corresponding to a sequence of impending lane changes.

4. The method according to claim 1, wherein the configured lateral distance is set in such a way that the reference line maps an overall appearance of the lane boundary in the field of view through the vehicle window onto the field of view of the display device without
(i) intersecting a boundary of the field of view of the display device in the direction of the lane boundary and/or
(ii) distorting the perspective of the reference line compared to the perspective of the lane boundary.

5. The method of claim 1, wherein the configured lateral distance is set in such a way that the reference line maps an overall appearance of the lane boundary in the field of view through the vehicle window onto the field of view of the display device, wherein
(i) the configured lateral distance is set using a ratio between a width of the field of view through the vehicle window and a width of the field of view of the display device, and/or
(ii) the configured lateral distance is set proportionally to a ratio between a width of the field of view through the vehicle window and a width of the field of view of the display device.

6. The method according to claim 1, wherein
(i) the reference line in the field of view of the display device in relation to an appearance of the lane boundary in the field of view through the vehicle window is represented in a corresponding perspective manner, and/or
(ii) the reference line in the field of view of the display device in relation to an appearance of the lane boundary in the field of view through the vehicle window is represented in a corresponding scaled manner, at a proportional ratio that corresponds to a ratio between
(a) a width of the field of view of the display device, and
(b) a width of the field of view through the vehicle window.

7. The method according to claim 1, wherein the reference line is configured as a scaled distance with respect to a boundary of the field of view of the display device in the direction of the lane boundary, and wherein the distance in relation to a distance between the lane boundary and a corresponding boundary of the field of view through the vehicle window is set in a scaled manner, at a proportional ratio corresponding to a ratio between
(i) a width of the field of view of the display device, and
(ii) a width of the field of view through the vehicle window.

8. The method according to claim 1, wherein
(i) the reference line is represented by a plurality of shapes, symmetrically arranged with respect to one another,
(ii) the reference line is represented by a shading of a depicted lane of the vehicle, which is represented with greater intensity in the direction of the lane change prompt,
(iii) the reference line is represented by a progression of a pattern of a depicted lane of the vehicle, which is represented more densely in the direction of the lane change prompt,
(iv) the reference line is presented by a color progression of a depicted lane of the vehicle, which changes in the direction of the lane change prompt, or
(v) different representations of the reference line are provided within the scope of user settings.

9. The method according to claim 1, wherein
(i) the lane change indication is represented in the form of a directional indication, in the form of an S-shaped arrow, which penetrates the reference line,
(ii) the lane change indication is represented by the reference line itself, by a curvature, flection and/or a bend of the reference line in the direction of the lane change prompt, or
(iii) different representations of the lane change indication are provided within the scope of user settings.

10. A control device for activating a display device of a navigation system of a vehicle, comprising:
a memory device; and
a computing device, operatively coupled to the memory device, wherein the computing device is configured to
detect a lane change prompt;
determine a lane boundary for the lane change prompt;
provide a reference line for the lane boundary in a field of view of the display device; and
provide a lane change indication with using the reference line on the display device, wherein the reference line is arranged in a field of view of the display device in such a way that the reference line is positioned in a field of view through a vehicle window of the vehicle at a configured lateral distance with respect to the lane boundary.

11. The control device according to claim 10, wherein only one reference line is represented for a lane change prompt.

12. The control device according to claim 10, wherein, in the case of a multiple lane change prompt, a reference line is depicted in each case for each impending lane change, the reference lines being arranged corresponding to a sequence of impending lane changes.

13. The control device according to claim 10, wherein the configured lateral distance is set in such a way that the reference line maps an overall appearance of the lane boundary in the field of view through the vehicle window onto the field of view of the display device without
(i) intersecting a boundary of the field of view of the display device in the direction of the lane boundary and/or
(ii) distorting the perspective of the reference line compared to the perspective of the lane boundary.

14. The control device of claim 10, wherein the configured lateral distance is set in such a way that the reference line maps an overall appearance of the lane boundary in the field of view through the vehicle window onto the field of view of the display device, wherein
(i) the configured lateral distance is set using a ratio between a width of the field of view through the vehicle window and a width of the field of view of the display device, and/or
(ii) the configured lateral distance is set proportionally to a ratio between a width of the field of view through the vehicle window and a width of the field of view of the display device.

15. The control device according to claim 10, wherein
(i) the reference line in the field of view of the display device in relation to an appearance of the lane boundary in the field of view through the vehicle window is represented in a corresponding perspective manner, and/or
(ii) the reference line in the field of view of the display device in relation to an appearance of the lane boundary in the field of view through the vehicle window is represented in a corresponding scaled manner, at a proportional ratio that corresponds to a ratio between
(a) a width of the field of view of the display device, and
(b) a width of the field of view through the vehicle window.

16. The control device according to claim 10, wherein the reference line is configured as a scaled distance with respect to a boundary of the field of view of the display device in the direction of the lane boundary, and wherein the distance in relation to a distance between the lane boundary and a corresponding boundary of the field of view through the vehicle window is set in a scaled manner, at a proportional ratio corresponding to a ratio between
(i) a width of the field of view of the display device, and
(ii) a width of the field of view through the vehicle window.

17. The control device according to claim 10, wherein
(i) the reference line is represented by a plurality of shapes, symmetrically arranged with respect to one another,
(ii) the reference line is represented by a shading of a depicted lane of the vehicle, which is represented with greater intensity in the direction of the lane change prompt,
(iii) the reference line is represented by a progression of a pattern of a depicted lane of the vehicle, which is represented more densely in the direction of the lane change prompt,
(iv) the reference line is presented by a color progression of a depicted lane of the vehicle, which changes in the direction of the lane change prompt, or
(v) different representations of the reference line are provided within the scope of user settings.

18. The control device according to claim 10, wherein
(i) the lane change indication is represented in the form of a directional indication, in the form of an S-shaped arrow, which penetrates the reference line,
(ii) the lane change indication is represented by the reference line itself, by a curvature, flection and/or a bend of the reference line in the direction of the lane change prompt, or
(iii) different representations of the lane change indication are provided within the scope of user settings.

19. A display device of a navigation system of a vehicle, comprising:
a memory;
a control device comprising a memory and a computing device, the control device being configured to
detect a lane change prompt;
determine a lane boundary for the lane change prompt;
provide a reference line for the lane boundary in a field of view of the display device; and
provide a lane change indication with using the reference line on the display device, wherein the reference line is arranged in a field of view of the display device in such a way that the reference line is positioned in a field of view through a vehicle window of the vehicle at a configured lateral distance with respect to the lane boundary.

20. The display device according to claim 19, wherein only one reference line is represented for a lane change prompt, or, in the case of a multiple lane change prompt, a reference line is depicted in each case for each impending lane change, the reference lines being arranged corresponding to a sequence of impending lane changes.
